(19) United States
(12) Patent Application Publication
(10) Pub. No.: US 2004/0237107 A1
(43) Pub. Date: Nov. 25, 2004

(54) Media distribution systems and methods

(76) Inventor: Mathew L. Staples, Fort Collins, CO (US)

Correspondence Address: ALPINE LAW GROUP, LLC, 9249 S. BROADWAY BLVD, UNIT 200-201, HIGHLANDS RANCH, CO, 80129, US

(21) Appl. No.: 10/848,306

(22) Filed: May 18, 2004

Related U.S. Application Data
(60) Provisional application No. 60/471,884, filed on May 19, 2003.

(51) Int. Cl. H04N 5/445; H04N 7/173; G06F 13/00; G06F 3/00; G11B 21/08; G11B 7/085

(52) U.S. Cl. 725/47; 725/37; 348/563; 725/131

(57) ABSTRACT

Implementations described and claimed herein provide media distribution, e.g., in a building automation environment. An exemplary implementation includes reading electronic media content from a media source, converting the electronic media content to a computer-readable data stream including custom data for distributing the electronic media content, and delivering the computer-readable data stream to at least one client in a distributed environment.

### PRIORITY CLAIM

This application claims priority to co-owned U.S. Provisional Patent Application Ser. No. 60/471,884 for “Media Distribution Systems and Methods” of Mathew L. Staples (Attorney Docket No. CVN007-PRV), filed May 19, 2003, hereby incorporated herein for all that it discloses.

### TECHNICAL FIELD

The described subject matter relates to electronic media, and more particularly to systems and methods for electronic media distribution.

### BACKGROUND

Digital Versatile Disc (DVD) players are used to present audio/visual content, e.g., on a television, computer monitor, or stand-alone device. The DVD player typically includes a drive to read data from a DVD disc in the drive, and player logic to format the data for presentation. The player logic may also interact with the user to accommodate various preferences (e.g., fast-forwarding, scene selection).

The player logic may also “negotiate” with the drive to access copy-protected data on the DVD disc. Negotiation occurs on a repeated and continuous basis and is timing sensitive so as to prevent the data from being intercepted as it is sent from the drive to the player logic (e.g., by “hackers”). The timing of this negotiation requires that the player logic and the drive be located in close proximity to one another, thereby limiting the ability to distribute media from the DVD player (e.g., to different rooms in a building or home).

Although output from the DVD player may be analog to allow the display to be physically separated from the player, analog connections (e.g., coax cable) are limited in how far a signal can be carried without significant loss of quality. In addition, the DVD player and hence the output can only be controlled directly at the DVD player itself or via a remote control unit for the DVD player. Accordingly, the output of a single DVD player cannot be readily distributed among multiple displays in a building or home. To the extent that the signal can be delivered over limited distances, the building or home must be pre-wired with dedicated analog wiring.

### SUMMARY

Implementations described and claimed herein allow electronic media content to be physically separated from the display or other output device by essentially unlimited distances while maintaining connectivity via a computer network, such as, e.g., a local area network (LAN) and/or wide area network (WAN). The electronic media content (e.g., the video on the DVD disc) is converted to a computer-readable data stream having custom data. The computer-readable data stream may be distributed to one or more remote clients. The output may be controlled at the client, e.g., to fast forward or pause the video, using the custom data in the data stream.

In some implementations, articles of manufacture are provided as computer program products. One implementation of a computer program product provides a computer program storage medium readable by a computer system and encoding a computer program for media distribution. Another implementation of a computer program product may be provided in a computer data signal embodied in a carrier wave by a computing system and encoding the computer program to media distribution.

The computer program product encodes a computer program for executing a computer process that reads electronic media content from a media source, converts the electronic media content to a computer-readable data stream including custom data for distributing the electronic media content, and delivers the computer-readable data stream to at least one client in a distributed environment.

In other implementations, methods are provided. An exemplary method comprises reading electronic media content from a media source, converting the electronic media content to a computer-readable data stream including custom data for distributing the electronic media content, and delivering the computer-readable data stream to at least one client in a distributed environment.

Another exemplary method comprises receiving a computer-readable data stream at a client, converting the computer-readable data stream to electronic media content based on custom data included in the computer-readable data stream, and outputting the electronic media content.

### BRIEF DESCRIPTION OF THE DRAWINGS

FIG. 1 is a high-level diagram illustrating functional elements of an exemplary media distribution system;

FIG. 2 is a high-level diagram illustrating an exemplary media stream;

FIG. 3 is a process flow diagram illustrating exemplary operations for distributing a media stream;

FIG. 4 is a process flow diagram illustrating exemplary operations for controlling distribution of a media stream; and

FIG. 5 is a schematic illustration of an exemplary computing device that can be utilized to implement a media distribution system.

### DETAILED DESCRIPTION

Exemplary implementations of a media distribution system may be used to store and manage electronic media content, and to provide the electronic media content to any of a number of distributed clients where it can be controlled by the user, e.g., to fast forward, skip, access content menus, etc. Indeed, multiple clients may interact with the same media session. Although exemplary media distribution systems are illustrated herein with reference to MPEG-2 audio/visual (AV) content provided on a DVD disc, it is noted that electronic media content may also include, e.g., home and/or commercial video, electronic still photographs, and music or other audio to name only a few examples.

In an exemplary implementation, electronic media content is read from the media source at a host, thereby maintaining close proximity between the player application and the drive. The electronic media content is converted to a data stream including custom data for controlling output of the electronic media content at a client. The host then sends the electronic media content (e.g., audio/video output) to the client as a continuous, one-way digital stream over the network (e.g., as a digital MPEG-2 stream).

The data stream is sent at the appropriate rate for the client to output the media content (e.g., to display the video). Flags can be set in the data stream to indicate the output mode (e.g., fast forward, normal playback, rewind, etc.) to the client. The client decodes the data stream and converts it into a format suitable for a locally attached display.

Interactive commands may also be sent back to the host from the client. The host responds to the commands by changing its output stream so that all clients that are “tuned in” respond to the commands. Accordingly, the host need not be kept apprised of the number of clients “tuned in” or which clients are generating interactive commands.

In addition, one or more users may access the media content through different clients, either synchronously or asynchronously. By way of example, one user can watch a movie in the living room, while another user is watching the same movie in the bedroom. Both users can start the movie at the same time and watch it simultaneously. Alternatively, both users can be watching different scenes from the movie, or even different movies, at the same time. As another example, a user may start watching a movie in the living room, and then stop or pause the movie, and continue watching the movie where they left off, in another room, without having to take the media source (e.g., the DVD) to another media player.

Exemplary Architecture

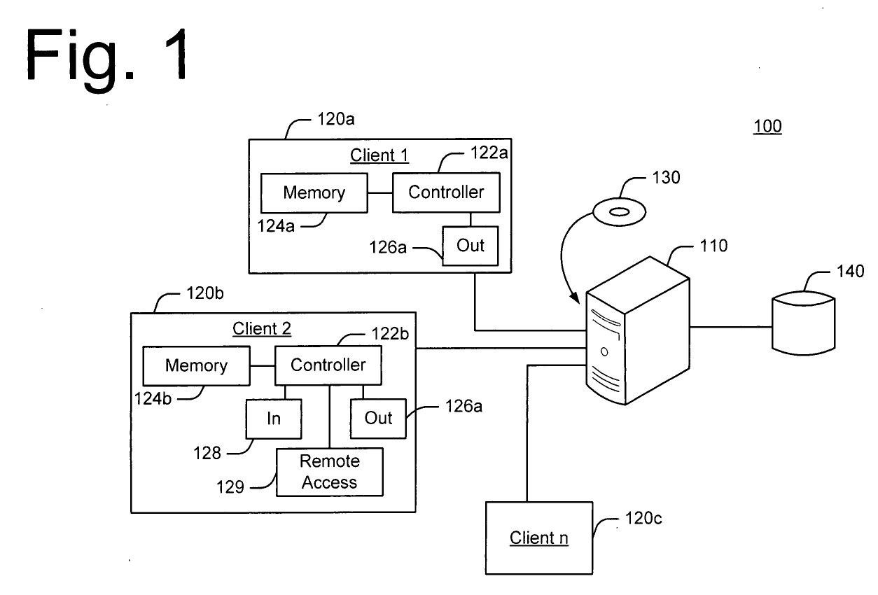

FIG. 1 is a high-level diagram illustrating functional elements of an exemplary media distribution system 100. Media distribution system 100 may be implemented to convert electronic media content to computer-readable format which may then be distributed to one or more other devices, e.g., for playback. In exemplary implementations, the signal may be split with little or no signal loss, and is not affected by transmission distances.

In an exemplary implementation, media distribution system 100 may include a host 110 and one or more clients 120a-c. The host 110 and clients 120a-c may be communicatively coupled via suitable communication network(s), such as a local area network (LAN) and/or wide area network (WAN). The host-client link may be bidirectional to facilitate device commands from the client, although a uni-directional link may be provided in other implementations.

Media distribution system 100 may be implemented to distribute electronic media content in any suitable format, such as, e.g., high-speed signal distribution with low-voltage differential signaling (LVDS), S-video, Digital Visual Interface (DVf), National Television Standards Committee standards, PAL standard, and SECAM standard, to name only a few.

Host 110 may be physically located in the same building as one or more of the clients 120a-c (hereinafter generally referred to as clients 120). For example, host 110 may be provided in a server room at a home or office building and one or more clients 120 may be provided in different rooms or offices in the same building. Alternatively, server 110 may be provided “off-site” (e.g., at a service provider) and one or more clients 120 provided at various other locations (e.g., different units in an apartment building).

Media distribution system 100 may also be implemented in a distributed server environment. For example, media content may be provided from a main server to a local server for time-shifting and later playback. As another example, a local server may be used to record media content, which may then be transferred to the main server or made available to the clients 120.

The terms “host” and “client” used herein refer to the hardware and software (e.g., a computer system) used to perform various computing services. For example, a host may be implemented as a server computer that is dedicated to server applications or that also runs other applications. Although a client may be implemented as a stand-alone desktop or laptop personal computer (PC), the client may display or otherwise output the electronic media content without needing extensive processing power. For example, clients may be implemented as physically smaller and less expensive electronic appliances.

For purposes of illustration, one or more client (e.g., client 120a) may be implemented as a set-top box or display having a “hidden” or integral processor. Client 120a may include a controller 122a for providing basic functionality such as, e.g., start, stop, and contrast controls. Client 120a may also include computer-readable storage or memory 124a which may serve as, e.g., a RAM buffer. Controller 122a may be operatively associated with one or more output devices 126a such as, e.g., televisions, thin-film transistor (TFT) displays, plasma displays.

In another exemplary implementation, one or more client (e.g., client 120b) may be implemented as an interactive appliance. Client 120b may include a controller 122b operatively associated with computer-readable storage or memory 124b. For example, controller 122b may be an integrated processor (e.g., a Geode™ processor, commercially available from National Semiconductor Corporation; Santa Clara, Calif. 95050). The Geode™ processor family of integrated processors can be customized for specific functions, such as, e.g., controlling Microsoft Corporation's Windows® Powered Smart displays.

Client 120b may also include one or more output devices 126b (e.g., televisions, thin-film transistor (TFT) displays, plasma displays) and input devices 126b (e.g., a keypad, touch screen). Optional remote control access 129 (e.g., a conventional infrared device) may also be provided.

As discussed briefly above, media distribution system 100 may be used to distribute electronic media content to one or more clients 120. Electronic media content may be transferred from a media source 130 to computer-readable format and stored at a media library 140 for distribution to one or more of the clients 120. Alternatively, the electronic media content may be directly distributed to the clients 120 without being stored at media library 140.

Before continuing, it is noted that electronic media content may be derived from any suitable media source 130 in any of a wide variety of different formats. For example, the media source may comprise television signals, CDs or DVDs (including blue-laser DVDs) with related media players, and content available via the Internet, to name only a few examples.

In addition, electronic media content may be provided from media source 130 to host 110 via any suitable analog or digital signal link, such as, e.g., the link provided between a conventional DVD drive and a PC (e.g., for a DVD disc), the link from a video capture card to a PC, or the link from a digital tuner to a digital TV.

Continuing our discussion, software may be provided to transfer the electronic media content from media source 130 onto a read/write storage medium operatively associated with host 110, such as, e.g., a computer hard disk drive (this process is also known as “ripping” the electronic media content). For example, audio content on a CD may be ripped and encoded into MP3 files. Software for ripping electronic media content is conventionally available for transferring or releasing electronic media content from its read-only format. The software may also include program code for decrypting and/or removing copy protection (e.g., licensed by the owner).

The electronic media content may be stored by the host 110. For example, electronic media content may be stored in one or more media libraries 140. Additional media libraries 140 or partitions (not shown) may be provided for backup, for different media categories (e.g., children's movies, home movies, movies available on a fee basis, music). Multiple media libraries 140 or partitions may be presented to the users as a single media library, or as separate libraries or partitions.

Electronic media content may be managed, e.g., using computer-readable program code for managing one or more media library 140 or partitions. For example, management software may include program code for adding, removing and/or modifying electronic media content stored in media library 140.

In addition, program code may also be provided for managing access to electronic media content on one or more media library 140 or partitions. For example, when a user requests access to electronic media, the client 120 may query host 110 with the user's selection. Program code at the host 110 may reply by delivering an electronic programming guide (e.g., a list of titles, audio stations, TV channels, etc.) to the client.

Program code may also be provided for user-interaction. For example, program code may be provided at the server for replying to a client's query with the user's preferences (e.g., the user's chapter selection, language, etc.).

The foregoing description of exemplary media distribution system 100 is provided in order to illustrate various configurations. It is noted, however, that media distribution systems 100 may also be configured in conjunction with any of a wide range of other types of devices that are now known or may be developed in the future.

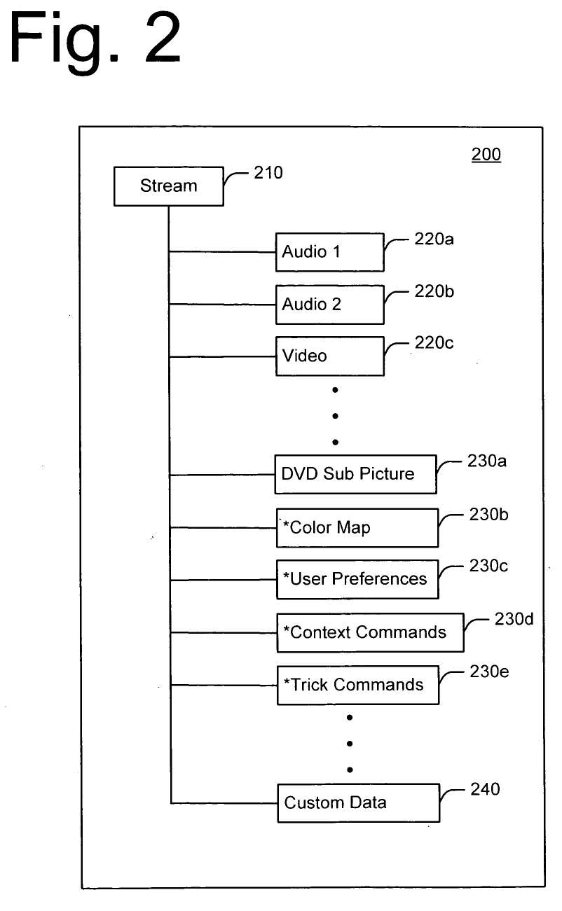

FIG. 2 is a high-level diagram illustrating an exemplary media stream 200, such as may be used to deliver electronic media content to a client in a media distribution system. In an exemplary implementation, the electronic media content is formatted as packets that can be discarded after the electronic media content has been output (e.g., displayed). Buffering may be provided at different stages during the delivery wherever suitable to decrease or eliminate the effects of network congestion.

Media stream 200 may be formatted according to the MPEG2 standard for video and may include a number of substreams 220a-c, 230a-e, and 240 formatted according to the DVD standard. The MPEG-2 standard generally comprises three main components: Video (ISO/IEC 13818-2), Audio (ISO/IEC 13818-3), and Systems (13818-1), where the Systems portion of the specification describes how the so-called “elementary streams” (e.g., video and audio) are carried within an MPEG-2 stream. Generally, there are two types of MPEG-2 system streams: Program Stream (PS) and Transport Stream (TS). The former is typically used for read-only media (e.g., DVDs) while the latter is used for transport over networks (e.g., digital cable TV or satellite broadcast). In addition, the PS may only include one program (i.e., the audio and video streams that make up a single movie), while the TS may include multiple programs (e.g., multiple TV channels may be simultaneously sent in a single TS).

While the MPEG-2 specification defines MPEG-2 audio and MPEG-2 video, the Systems component of the specification also allows other types of data to be sent in “private” sub-streams. The format of such private data is not specified by MPEG-2 and is therefore application-specific.

DVD Video employs such an application-specific extension of MPEG-2. It defines (among other things) how Dolby and AC3 audio, and subpicture video can be carried in private MPEG-2 sub-streams. MPEG-2 itself makes no mention of these audio types, and in fact a generic MPEG-2 decoder would not be able to make use of this data as it would only be usable by a decoder that understands the DVD-Video application of MPEG-2.

In addition to AC3 and Dolby audio, DVD uses private streams for picture overlays, menu button information, and “program chain” information that the player uses to extract data from the correct portions of the DVD disc.

Not all of the information for decoding a DVD MPEG-2 stream is in the MPEG-2 data itself. In addition to its extension of MPEG-2, DVD Video specifies other information that is separate from MPEG-2, and some of this information is needed to properly decode the MPEG-2 data stream. This information may be added by providing the non-MPEG-2 data in custom packets 230b-e, as designated by asterisks (*) in FIG. 2.

By way of example, the colors used in picture overlays (sub-pictures) are not specified directly in the overlay data. Rather, the sub-picture data contains only indexes into a “color map”. A color map is an indexed list of colors. It allows one to create an image with some limited number of distinct colors by using index values instead of direct color values. When the image is rendered, the color map is used to map the index values to real color values. The advantage is that the packet size for an image is reduced. For example, an image having 4 distinct colors to be stored in 2 bits per pixel instead of 24 bits per pixel. This color map is not part of the MPEG-2 data on the DVD.

Furthermore, decoding sub-pictures used in interactive DVD menus is also affected by the menu button information. Though much of that information is part of the MPEG-2 data stream (as a DVD private sub-stream), the index of the currently selected button is not part of that data stream.

There are also typically several audio, video and sub-picture sub-streams in a DVD MPEG-2 stream. The MPEG-2 stream does not provide information for selecting between these sub-streams at the appropriate time. In addition, DVD media is typically provided with program code that the player logic executes in response to certain types of user commands, such as pressing the enter button on the DVD remote control. Said another way, the player logic implements a virtual machine on which executes the DVD program code. This means that the way a DVD player behaves when a user presses a button on their remote control is determined by the code on the DVD disc, not by the player logic.

The effect of executing the code on a DVD is usually to change to a different segment of the MPEG-2 content and/or to change the currently selected button, or audio/video/sub-picture stream. Thus, from the point of view of the MPEG-2 decoder, the out-of-band information to decode sub-pictures, etc., can change at any time.

Because of these out-of-band data elements, and the dynamic nature of DVDs, decoding of DVD MPEG-2 data is typically an integral part of the overall DVD player logic.

In an exemplary implementation, the server performs data extraction from the media source (e.g., the DVD disc), executes the program code, and sends a continuous one-way MPEG-2 stream to the client(s). This implementation allows the bulk of the player logic to reside on the server, which in turn minimizes the load on the client and allows for a wide range of client-side hardware solutions. The client's responsibilities may thus comprise decoding the MPEG-2 stream (along with the DVD extensions and logic extensions described below), and forwarding user commands to the server (e.g., “up button pressed”). It is understood, however, that additional hardware and/or software may be provided at the client.

For clients to properly decode the received MPEG-2 data, the out-of-band data described above may be dynamically added to the stream as custom packets. Generally, there are two basic types of custom packets. The custom packets may comprise content independent data (e.g., fast-forward, rewind, etc.) and/or content dependent data (e.g., camera angle, currently selected button or other state information, color map, etc.). By way of example, the following data may be sent as packets of type private_stream_{—}2:

The 24 Byte color map from the current program chain—sent before the first packet in the program chain, and periodically thereafter.

The current sub-picture and audio sub-stream indexes—sent before the first packet after they are changed, and periodically thereafter.

The current angle index—sent before the first packet after it is changed, and periodically thereafter.

The current selected (highlighted) button index—sent before the first packet after it is changed, and periodically thereafter. The action state is assumed “in-active” until the client receives an action-state packet (see the next bullet item).

An action-state flag indicating that the currently selected button has been activated—sent once before the first packet after a button has been activated, and is valid until the client receives the next “selected-button-index” packet.

An error indicator—sent once after a user command has failed (for example, if the action is not permitted at the present time).

A still-frame flag, indicating that the data stream is about to be interrupted and that the client should flush any buffered data through to the display—sent after the last byte of a still frame has been sent. The still-frame data, followed by this flag, are periodically resent until the continuous playback is resumed.

In addition, the MPEG-2 standard defines mechanisms for so-called “trick mode” playback (e.g., fast-forward, pause, or rewind at various speeds). However, the flags to achieve this behavior may not be set in the data extracted from the media source. At least two options for handling trick mode playback are contemplated. In one exemplary implementation, the MPEG-2 data may be dynamically modified as the trick mode is changed on the server. Alternatively, additional private_stream_{—}2 packet types may be added to the stream to indicate changes in trick-mode state.

Of course media stream 200 is not limited to these exemplary custom packets, as will be readily appreciated by one skilled in the art after having become familiar with the teachings of the present invention.

Non-critical or transitory data are sent only once. Other data may be resent periodically to allow clients to “tune in” to the data stream in mid broadcast and begin decoding and displaying the content as quickly as possible. This also allows for some degree of robustness in unreliable networking situations. The frequency at which this information is repeatedly sent is determined by a trade-off between “tune-in” time and network bandwidth (though this information is typically very low bandwidth as compared to the bulk of the MPEG-2 data in the stream).

The data may be organized as custom packets within private_stream_{—}2 packets in any suitable manner. The packet types and their formats are well-defined and consistent, and the packet type IDs (specified by the first byte of the enclosing private_stream_{—}2 packet) do not conflict with the IDs of packets defined by the DVD Video specification.

When the media stream is received at the client, program code provided at the client reads the media stream, including any substreams and custom data packets. The client may use commercially available decoders, although it may need to extract the custom packets from the stream if the decoder does not handle packet types it does not recognize. That is, the custom packets may be removed or discarded at the client. For example, the client-side decoder software parses the MPEG-2 stream it receives from the server, utilizing any custom packets, and passing all other packets to the decoder. In one implementation, removal of a packet from the stream may comprise not forwarding the packet to the decoder.

The client also decodes sub-pictures to combine with the decoded media data (e.g., as described by the DVD Video specification). The client then outputs the stream, referring to the custom packets as needed.

In another implementation, the custom packets may provide error reporting or other feedback from the server. Other implementations are also contemplated as being within the scope of the invention.

By way of example, security features may be implemented pursuant to a licensing agreement with providers of commercial media content. In one implementation, media distribution system may comprise program code for an encryption/decryption protocol. Other security features may also be implemented. For example, MPEG-2 defines general mechanisms for facilitating “conditional access” that can also be implemented.

Exemplary Operations

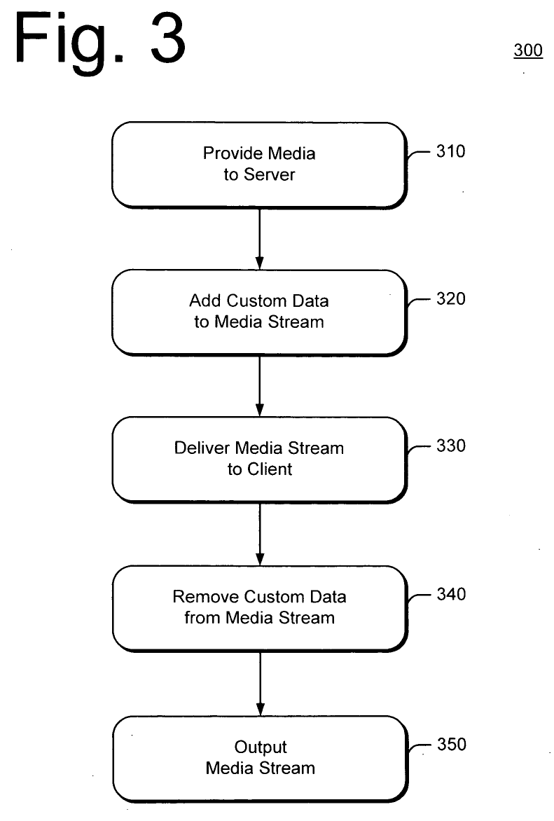

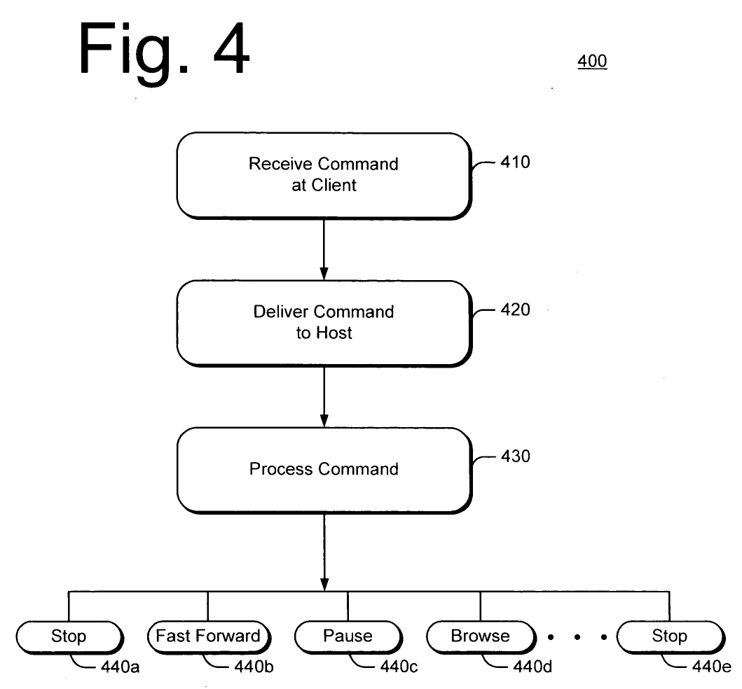

FIGS. 3 and 4 illustrate exemplary methods for implementing media distribution. The methods described herein may be embodied as logic instructions. When executed on a processor (or processing devices), the logic instructions cause a general purpose computing device to be programmed as a special-purpose machine that implements the described methods. In the following exemplary operations, the components and connections depicted in the figures above may be used to implement media distribution.

FIG. 3 is a process flow diagram illustrating exemplary operations 300 for distributing a media stream. In operation 310 the media content is provided to the server from a media source. The media content may be stored on computer-readable storage (e.g., in media library), or streamed directly to one or more of the clients. In operation 320 the media content may optionally be formatted to add custom data to the media stream, as described in more detail above.

When a user desires access to particular media content (e.g., a song, movie, etc.), the user makes a selection. For example, the user may browse a menu of media content available from the media library. Of course the user may make other selections in addition to the media selection. For example, the user may select a particular configuration for the media content (e.g., language, scene, etc.). 100571 In operation 330 the client delivers the user's selection to a host. The host determines the user's selection and configuration based on the request and delivers a corresponding media stream to the client. In an exemplary implementation, media stream may comprise an address that identifies the media stream. The server provides the client with the address so that the client receives the desired media stream. Accordingly, more than one media stream may be provided simultaneously to different clients. In addition, the user may move to another room and “pick up where they left off” by identifying the media stream by address at the other client. The media stream can then be delivered to the other client for the user without having to restart the selection process.

In operations 340-350, the client receives a media stream and outputs the media content for the user. The client reads the media stream and formats the media content based on data provided by the custom data. As mentioned above, the client may optionally remove the custom data (operation 340) before presenting the media content (operation 350) to reduce or eliminate the occurrence of errors where the output device does not recognize user-defined data.

FIG. 4 is a process flow diagram illustrating exemplary operations 400 for controlling distribution of a media stream. For example, the user may enter one or more commands using a touch-screen, keypad or keyboard, remote control device, PC mouse, or other suitable device. Accordingly, the user is provided with a “rich” interactive experience.

In operation 410, a command is received at the client. The command is delivered to the host in operation 420. The command is processed in operation 430. Exemplary commands may include, e.g., Stop 440a, Fast Forward, 440b, Pause 440c, Browse 440d, and Stop 440e, to name only a few examples.

In an exemplary implementation, the user may use commands to select and configure the media content via a browser interface. For example, the user may be provided with a media catalog. The user may select among choices such as music, video, etc. Once the user has selected the type of media content, the user may select the specific media content (e.g., video title). As another example, the client may display an electronic programming guide from which the user may make a selection. The client displays the menu for the user.

The user may also use the commands for multicast control. That is, the user is able to select and configure media content at one client, and then move to another client and resume playback and/or reconfigure the media content at the other client.

In another implementation, the commands may be used to control the media content. For example, the user may exercise conventional control or “trick” commands (e.g., Stop, Fast-Forward, and scene selection) that are available with conventional set-top players (e.g., a DVD player). The server responds by providing a media stream corresponding to the requested command.

In yet another example, the command may be to pause the media stream. The server may send a flush command to the client. The flush command instructs the client to output the current media frame until the server continues sending the media stream (e.g., when the user releases the pause function) and erase the media stream that may already be in the buffer. The flush command reduces or eliminates the occurrence of unintended playback discontinuity caused by buffering (e.g., displaying video already in the buffer after the media stream has been paused).

After sending the flush command, the server repeatedly sends the still frame information, however, not at playback speed (e.g., 1 frame per second instead of 30 frames per second). Accordingly, other clients that “tune in” later will still receive the still frame information and be able to output the paused media stream (e.g., a still frame video). When the client requests that the server resumes sending the media stream (e.g., the pause is released), the server continues to send the media stream at playback speed. This implementation may also be used where the media stream remains unchanged over time (e.g., a menu, displaying a still picture).

The invention is not limited to the exemplary implementations shown and described in FIGS. 3 and 4. For example, in other implementations some or all of the control features can be provided at the client itself. That is, the controller at the client can respond to input from the user. For example, control for audio/display properties and/or menus can be provided at the client itself without sending these commands to the server for processing.

Exemplary Computing Device

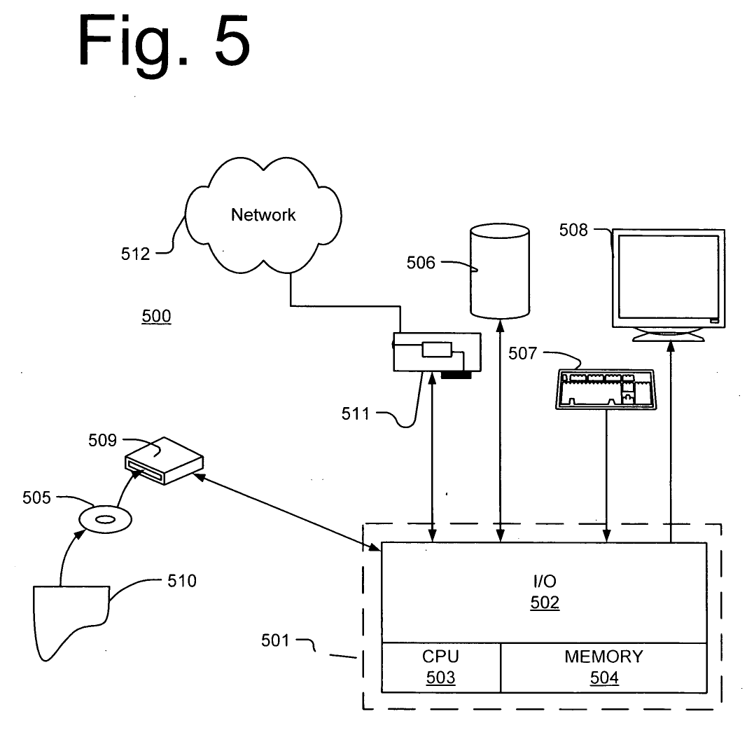

FIG. 5 depicts an exemplary general purpose computer 500 capable of executing a program product for distributing electronic media content. One or more general purpose computer 500 may be implemented for “ripping” electronic media content from a media source, storing and managing stored electronic media content (e.g., at a media library), and/or delivering and controlling delivery of the electronic media content in a distributed environment.

In such a system, data and program files may be input to the computer, including without limitation by removable or non-removable storage media or a data signal propagated on a carrier wave (e.g., data packets over a network). The computer 500 may be a conventional computer, a distributed computer, or any other type of computing device.

The computer 500 can read data and program files, and execute the programs and access the data stored in the files. Some of the elements of an exemplary general purpose computer are shown in FIG. 5, including a processor 501 having an input/output (I/O) section 502, at least one processing unit 503 (e.g., a microprocessor or microcontroller), and a memory section 504. The memory section 504 may also be referred to as simply memory, and may include without limitation read only memory (ROM) and random access memory (RAM).

A basic input/output system (BIOS), containing the basic routines that help to transfer information between elements within the computer 500, such as during start-up, may be stored in memory 504. The described computer program product may optionally be implemented in software modules loaded in memory 504 and/or stored on a configured CD-ROM 505 or other storage unit 506, thereby transforming the computer system in FIG. 5 to a special purpose machine for implementing the described system.

The I/O section 502 is optionally connected to keyboard 507, display unit 508, disk storage unit 506, and disk drive unit 509, typically by means of a system or peripheral bus (not shown), although it is not limited to these devices. The system bus may be any of several types of bus structures including a memory bus or memory controller, a peripheral bus, and a local bus using any of a variety of bus architectures.

Typically the disk drive unit 509 is a CD-ROM drive unit capable of reading the CD-ROM medium 505, which typically contains programs 510 and data. Computer program products containing mechanisms to effectuate the systems and methods in accordance with the present invention may reside in the memory section 504, on a disk storage unit 506, or on the CD-ROM medium 505 of such a system. Alternatively, disk drive unit 509 may be replaced or supplemented by a floppy drive unit, a tape drive unit, or other storage medium drive unit. The network adapter 511 is capable of connecting the computer system to a network 512. In accordance with the present invention, software instructions directed toward accepting and relaying access information (e.g., authentication and security data) may be executed by CPU 503, and databases may be stored on disk storage unit 506, disk drive unit 509 or other storage medium units coupled to the system.

The drives and their associated computer-readable media provide nonvolatile storage of computer-readable instructions, data structures, program modules and other data for the computer 500. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

The computer 500 may operate in a networked environment using logical connections to one or more remote computers. These logical connections are achieved by a communication device 511 (e.g., such as a network adapter or modem) coupled to or incorporated as a part of the computer 500. Of course the described system is not limited to a particular type of communications device. Exemplary logical connections include without limitation a local-area network (LAN) and a wide-area network (WAN). Such networking environments are commonplace in office networks, enterprise-wide computer networks, intranets and the Internal, which are all exemplary types of networks.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method comprising:
reading electronic media content from a media source;
converting the electronic media content to a computer-readable data stream including custom data for distributing the electronic media content; and
delivering the computer-readable data stream to at least one client in a distributed environment.

2. The method of claim 1, wherein delivering the computer-readable data stream is at a predetermined rate for the at least one client to output the electronic media content.

3. The method of claim 1, further comprising setting a flag in the computer-readable data stream to indicate an output mode for the client.

4. The method of claim 1, further comprising formatting the computer-readable data stream to include custom data for interacting with the electronic media content at the at least one client.

5. The method of claim 1, further comprising receiving a command signal from the client to control delivery of the computer-readable data stream.

6. The method of claim 1, further comprising delivering a menu for the electronic media content to the at least one client.

7. The method of claim 1, wherein the computer-readable data stream is output by a host synchronously to a plurality of clients.

8. The method of claim 1, wherein the computer-readable data stream is output by a host asynchronously to a plurality of clients.

9. A method comprising:
receiving a computer-readable data stream at a client;
converting the computer-readable data stream to electronic media content based on custom data included in the computer-readable data stream; and
outputting the electronic media content.

10. The method of claim 9, further comprising issuing an interactive command to control the electronic media content delivered to the client.

11. The method of claim 10, wherein the interactive command is based on a content menu at a host.

12. The method of claim 10, wherein the interactive command is based on a control menu at a source.

13. The method of claim 9, further comprising issuing a trick command to control the electronic media content delivered to the client.

14. A computer program product encoding computer programs for executing a computer process, the computer process comprising:
reading electronic media content from a media source;
converting the electronic media content to a computer-readable data stream including custom data for distributing the electronic media content; and
delivering the computer-readable data stream to at least one client in a distributed environment.

15. The computer program product of claim 14 wherein the computer process further comprises delivering the computer-readable data stream at a predetermined rate for the at least one client to output the electronic media content.

16. The computer program product of claim 14 wherein the computer process further comprises setting a flag in the computer-readable data stream to indicate an output mode for the client.

17. The computer program product of claim 14 wherein the computer process further comprises formatting the computer-readable data stream to include custom data.

18. The computer program product of claim 14 wherein the computer process further comprises receiving a command signal from the client to control delivery of the computer-readable data stream.

19. The computer program product of claim 14 wherein the computer process further comprises delivering a menu for the electronic media content to the at least one client.

20. The computer program product of claim 14 wherein the computer process further comprises outputting the computer-readable data stream synchronously to a plurality of clients.

21. The computer program product of claim 14 wherein the computer process further comprises outputting the computer-readable data stream asynchronously to a plurality of clients.
